(19) United States
(12) Patent Application Publication
(10) Pub. No.: US 2021/0394195 A1
(43) Pub. Date: Dec. 23, 2021

(54) CLEAN COAL PRODUCTION SYSTEM AND METHOD

(71) Applicants: Peijing YANG, Bear, DE (US); Gaoling YANG, Lvliang (CN)

(72) Inventors: Peijing YANG, Bear, DE (US); Gaoling YANG, Lvliang (CN)

(21) Appl. No.: 16/905,730

(22) Filed: Jun. 18, 2020

(51) Int. Cl. B03B 9/00; B03B 7/00

(52) U.S. Cl. CPC B03B 9/005; B03B 7/00

(57) ABSTRACT

A clean coal production system and method for treating coal refuse (waste) resulted from coal mining or coal washing plants by extracting substantial remaining coal components from said coal refuse (waste) and turning them into clean (fine) coal products of much higher market value wherein the necessary water usage is recovered, recycled, and reused in a closed setting (ecosystem) to minimize environmental concerns.

### FIELD OF THE INVENTION

The disclosures in the present invention relate to a clean coal production system and method for extracting clean coal from coal refuse (coal waste) produced by coalmines and coal preparation plants (also known as coal washing or processing plants or coal washeries). The disclosed clean coal production system and method can also be used in conjunction with coal washing or preparation plants or with coal mining process to decrease the amount of coal refuse resulted from the coal washing or preparation plants or from coal mining.

### BACKGROUND OF THE INVENTION

Coal is one of major fossil fuel energy sources in the world. Coal is widely used in electric power generation, iron and steel industry, cement industry, gasification, liquefaction, heating, and other purposes. The top coal producing and consuming countries are China, United States, India, Australia, Indonesia, Russia, South Africa, Germany, and Poland.

Using coal as an energy source has certain advantages, e.g., abundant supply, high predictability, low capital investment, available emission-reducing carbon capture and storage (CCS) technologies, convertible into different energy formats, and full-time availability (as opposed to solar and wind). On the other hand, certain disadvantages are associated with the use of coal, e.g., non-renewable, high level of carbon dioxide per British Thermal Unit (BTU), radiation source, other pollutants to air, water, and soil, health concerns from coal mining, coal washing, and emissions, landscape and biomass destruction, and even population resettlement. Regardless of pros and cons from using coal, it will remain a significant part of world's energy sources for the foreseeable future.

The main environmental challenges from coal mining and coal processing (e.g., coal washing or preparation) are coal waste management, land use or reuse, and pollutions. Coalmines and coal processing plants have accumulated millions upon millions of tons of coal refuse (coal waste) across the coal production countries and regions, sometimes over many years or even decades.

The US Environmental Protection Agency (EPA) provides coal refuse's definition as “waste products of coal mining, physical coal cleaning, and coal preparation operations (e.g., culm, gob, etc.) containing coal, matrix material, clay, and other organic and inorganic material” 40 C. F. R., Chapter I, Part 60, § 60.251 (g). Others also described coal refuse as a by-product of coal mining activities, not including overburden, and coal preparation and processing operations, which has been spread on the land.

The coal refuse (coal waste) left behind from coal mining and coal washing operations are hazardous. The residual coal components in coal refuse (coal waste) cannot be recovered by traditional coal mining and coal processing (coal washing) methods, due to technical, economical, and sometimes, historical reasons. Take Pennsylvania, for example, as one of the major coal production states in the US, its commercial coal mining began in 1800. By some estimation, the amount of coal refuse associated with historical mining operations in Pennsylvania may range from 200 million to 8 billion cubic yards. The negative environmental and economic implications of coal refuse (coal waste) last a long time and are still largely in existence in the affected communities of coal mining regions even long after the coalmines and coal washing plants ceased operations for many years. In fact, the older the coal refuse waste, the more deeply buried, higher the level of coal component contained therein, causing more environmental pollutions, the more difficult and expensive to treat the same.

Traditional coal mining operations require the use of large amount of water, the runoff of which is a major contributor to environmental pollutions, coal waste generation, and depletion of a valuable natural resource (e.g., ground and surface water level reduction). In general, raw coal, which contains various impurities and non-coal materials, excavated from underground and surface mines have to be processed in coal preparation and washing plants (coal washeries) to yield marketable and commercially desired coal products. The coal washing plants also require significant amount of water use, similar to coal mining, contributing to environmental pollutions and waste problems.

Coal preparation, washing, or cleaning is a process of removing non-coal materials (defined as containing no tangible heating value) such as soil, rock, or other impurities, from raw coal produced by coal mining. Coal washing process usually involves (a). initial preparation, (b). clean (fine) coal processing, (c). coarse coal processing, and (d). final processing. By coal washing process, raw coal produced from coalmines can be separated into (a). coal gangue, (b). clean coal, (c). coal middlings, and (d). coal slime or coal refuse (also known as coal washing waste).

Coal refuse (slime or waste) takes up tremendous land space that can otherwise be used for more productive purposes. Millions upon millions of tons of coal refuse (slime or waste) have been piled up over the years, sometimes many decades, formed unsightly coal-waste-mountains ubiquitously seen in coal production regions around the world. There have been numerous documented mudslide and spontaneous combustion incidences from coal refuse (waste) sites, further polluting the air, water, and the land, and sometimes causing human fatalities. The coal refuse piles may also attract additional illegal waste dumping. The spontaneous combustion may start as some smoldering that may last for a long time, and then evolve into open flames and raging fire. To extinguish the coal refuse fire and reclaim the coal-refuse-occupied land require millions of dollars.

Efforts have been made in recent years on reclaiming the coal-refuse-occupied land by planting trees or grow other vegetation over the targeted land tracks and develop them into outdoor recreation facilities. These efforts require applying layers, sometimes several feet, of top soil onto the to-be-reclaimed land, probably extracted and removed from somewhere else that can also raise environmental concerns. The main deficiency for these reclaiming efforts is that they do not directly address the root problem itself—the coal refuse (slime or waste), because they neither decrease the amount of the existing coal refuse (slime or waste) nor change its nature or compositions, thus, are mostly on the surface and cosmetic. Often, even after years of the reclaiming efforts, the targeted sites are still lack of trees or vegetation due to their poor growth on such coal refuse infused land.

The invention disclosed herein is to provide a technical solution for extracting the useful coal components from coal mining and coal processing/washing refuse (coal waste). Additionally, the water used in the disclosed invention is recovered, recycled, and reused in a closed setting (ecosystem), thus, not released into the environment in order to minimize pollutions and conserve water.

Specifically, the present disclosures provide a solution directed to the root-cause to the global scale coal refuse (slime) waste problems that long troubled the coal industry for decades, by extracting substantially useful coal components out of the coal refuse (slime) waste. As a result, the present invention can significantly decrease the existing amount of coal refuse (slime) waste, address environmental concerns, as well as provide viable employment and economic revival opportunities to coal producing regions, which have been, in general, in decline for the past few decades, due to more and more stricter rules and regulations implemented by various government agencies on coal mining and coal washing or preparation industry.

### SUMMARY OF THE INVENTION

A system and method for clean coal production are disclosed. The system and method can be used in a regular coal processing plant, either as a standing alone facility, or coupled with a traditional coal washing plant for treating the resulted coal refuse (slime) waste by extracting coal components out of the coal refuse (slime) waste and turning them into clean (fine) coal products of much higher heating, market, and economic value. Similarly, the system and method disclosed herein can be used to treat coal refuse (slime) waste from coalmines, extracting and generating clean (fine) coal products. The system and method can also be used for reclaiming, reforming, improving, and otherwise increasing the value of coal-waste-occupied land by extracting clean (fine) coal out of the wasteland. The disclosed system and method are designed as a closed setting (ecosystem) so that water as a valuable resource are recovered, recycled, and reused to minimize environmental concerns.

The above mentioned and other features and objects of the disclosures, and the manner of attaining them, will become more apparent and will be better understood by reference to the following descriptions of various embodiments of the invention taken in conjunction with the accompanying drawings.

### BRIEF DESCRIPTION OF THE DRAWINGS

The particular features, characteristics, and advantages of the provided disclosures for the present invention as well as other objects will become apparent from the following descriptions in connection with the accompanying drawings in which:

FIG. 1 is a flowchart diagram illustrating an exemplary engineered portion for preliminary selecting and screening coal from coal refuse waste generated by coal mining or coal washing according to the disclosed invention.

FIG. 2 is a flowchart diagram illustrating an exemplary engineered portion for a first cyclone separator of coal from coal refuse waste generated by coal washing according to the disclosed invention.

FIG. 3 is a flowchart diagram illustrating an exemplary engineered portion for repetitive selecting and screening of coal middlings produced by the first cyclone separator according to the disclosed invention. This repetitive selecting and screening process continues until the treatment for a given batch of starting materials from FIG. 1 (Flowchart I) have been finished.

FIG. 4 is a flowchart diagram illustrating an exemplary engineered portion for collecting and harvesting clean (fine) coal according to the disclosed invention.

FIG. 5 is a flowchart diagram illustrating an exemplary engineered portion for a second cyclone separator of coal gangue that is generated from the first cyclone separator according to the disclosed invention.

FIG. 6 is a flowchart diagram illustrating an exemplary engineered portion for repetitive selecting and screening treatment of coal middlings produced by the second cyclone separator according to the disclosed invention. This repetitive selecting and screening process continues until the treatment for a given batch of starting materials from FIG. 1 (Flowchart I) have been finished.

FIG. 7 is a flowchart diagram illustrating an exemplary engineered portion for collecting and harvesting coal middlings and recovering water from coal tailings according to the disclosed invention.

FIG. 8 is a flowchart diagram illustrating an exemplary engineered portion for separating water from coal gangue and coal tailings according to the disclosed invention.

FIG. 9 is a flowchart diagram illustrating an exemplary engineered portion for a first floating selection separator according to the disclosed invention.

FIG. 10 is a flowchart diagram illustrating an exemplary engineered portion for a second floating selection separator according to the disclosed invention.

FIG. 11 is a flowchart diagram illustrating an exemplary engineered portion for a third (coal middlings) floating selection separator to produce coal middlings and recover water according to the disclosed invention.

FIG. 12 is a flowchart diagram illustrating an exemplary engineered portion for water recover, recycle, and reuse in a closed setting (ecosystem) according to the disclosed invention.

FIG. 13 is a flowchart diagram illustrating an exemplary engineered portion for coupling the presently disclosed invention with a coal washing or coal processing plant.

FIG. 14—Schematic Diagram of Present Invention Coupled with Coal Washing Plant.

FIG. 15—Schematic Diagram of Present Invention.

Particular screen or sieve series, cyclone separator series, floating selection separator series, and presser-filter series, their combinations and sequence ordering arrangements, are meant to be illustration or exemplary purposes, but not as restrictions or limitations thereof.

### DETAILED DESCRIPTION

The embodiments described herein are not intended to limit the scope of the invention to the precise form disclosed. Rather, the embodiments described herein have been chosen and described to explain the principles of the invention and their applications and practical uses to best enable others skilled in the art to follow the disclosed teachings.

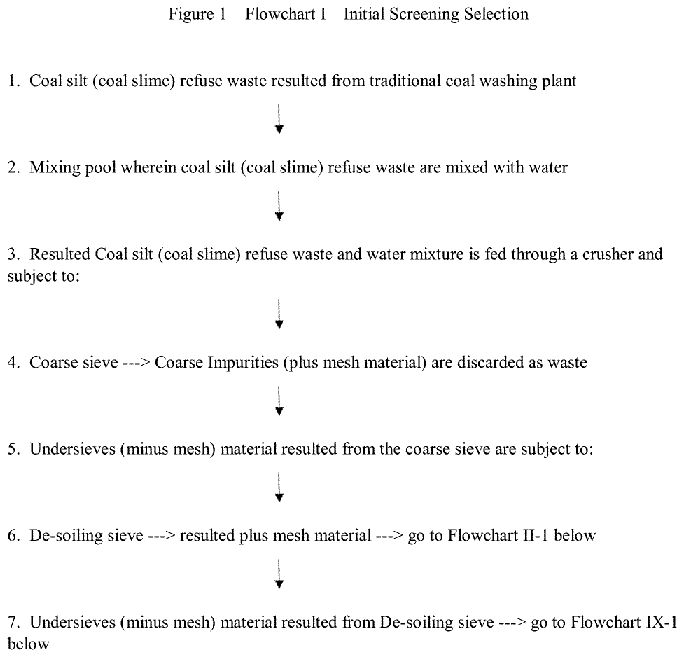

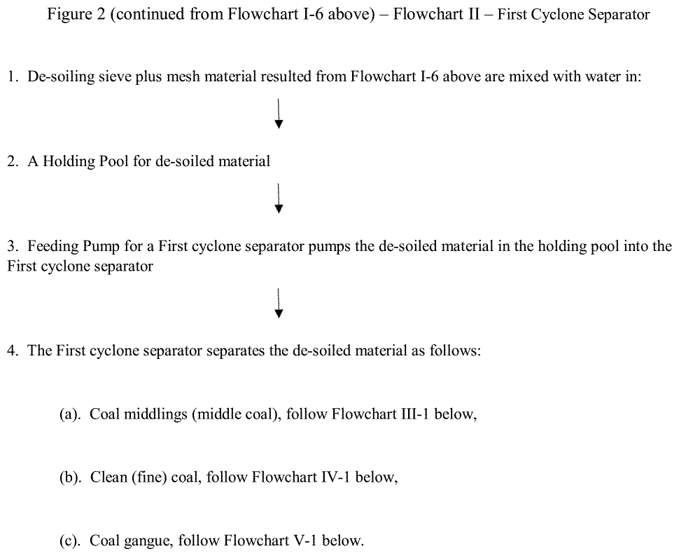

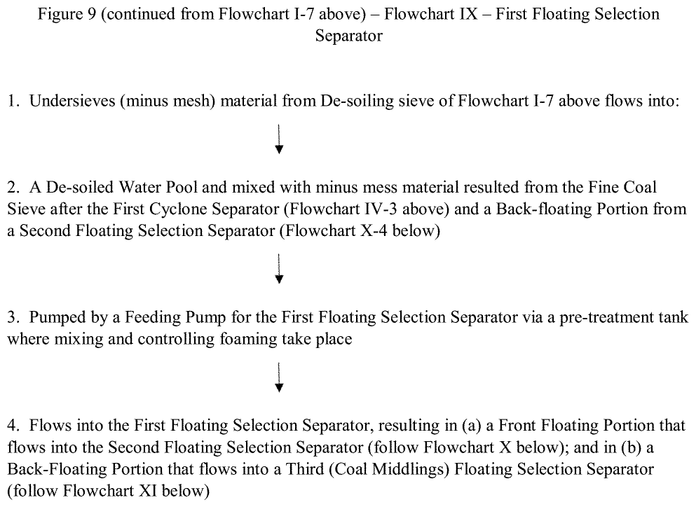

Referring to FIG. 1 (Flowchart I), a diagram illustrating an exemplary engineered portion for preliminary selecting and screening coal according to the disclosed invention from coal refuse waste generated by coal mining or coal washing. Specifically, coal silt (slime) refuse waste resulted from traditional coalmines or coal washing plants, or coal preparation and processing factories are collected for extracting clean (fine) coal product by the present invention disclosed herein. First, the coal silt (slime) refuse waste are mixed with sufficient amount of water in a mixing pool to form a slurry mixture. Then, the resulted slurry mixture of coal silt (slime) refuse waste and water are fed through a crusher to crush larger pieces, if any, therein and to improve the slurry mixture's consistency. The crusher-treated slurry mixture are loaded onto a coarse sieve. Coarse impurities such as large rock pieces (e.g., plus mesh material) on top of the coarse sieve are discarded as waste. Undersieves (e.g., minus mesh) material resulted from passing through the coarse sieve are subject to a de-soiling sieve. The plus mesh material that is produced from the de-soiling sieve shall follow FIG. 2 (Flowchart II-1) below for further treatment, while undersieves (e.g., minus mesh) material resulted from the de-soiling sieve shall go to FIG. 9 (Flowchart IX-1) below for further treatment.

Referring to FIG. 2 (Flowchart II), a diagram illustrating an exemplary engineered portion for a first cyclone separator of coal from coal refuse waste generated by coal mining or coal washing according to the disclosed invention. Specifically, the de-soiling sieve produced plus mesh material from FIG. 1 (Flowchart I-6) above are mixed with water in a holding pool for de-soiled material. Then, a feeding pump designated for the first cyclone separator pumps the de-soiled material in the holding pool into the first cyclone separator. The first cyclone separator separates the de-soiled material into the followings:

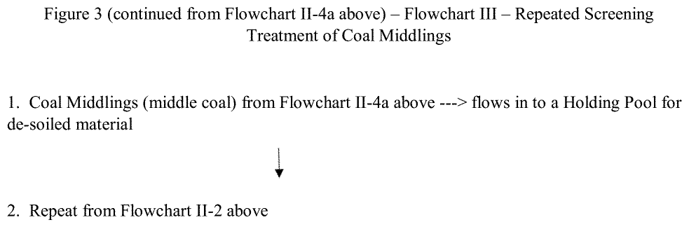

(a). coal middlings (middle coal), which shall follow FIG. 3 (Flowchart III-1) below,

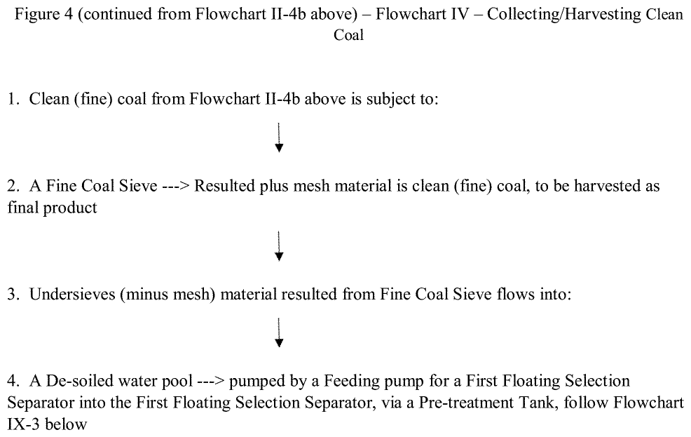

(b). clean (fine) coal, which shall follow FIG. 4 (Flowchart IV-1) below, and

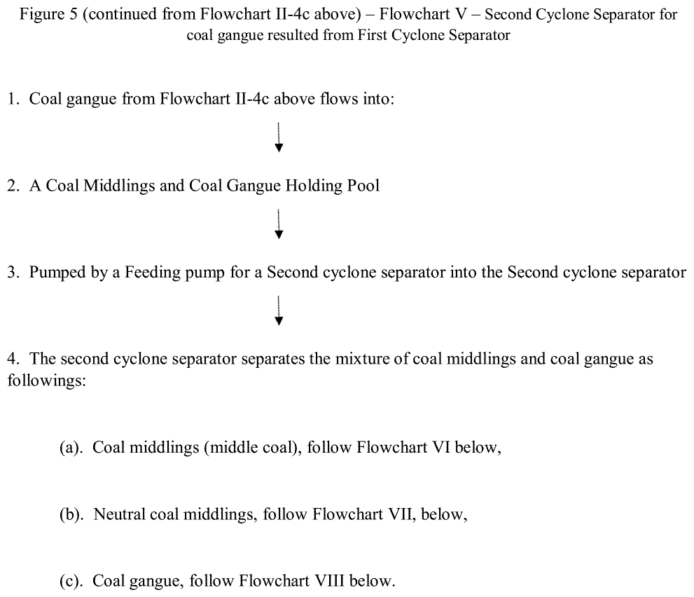

(c). coal gangue, which shall follow FIG. 5 (Flowchart V-1) below.

Referring to FIG. 3 (Flowchart III), a diagram illustrating an exemplary engineered portion for repetitive selecting and screening of coal middlings produced by the first cyclone separator according to the disclosed invention. Specifically, the coal middlings (middle coal) generated from the first cyclone separator as shown in FIG. 2 (Flowchart II-4a) above flows into a holding pool for de-soiled material, which is pumped back into the first cyclone separator repeatedly as shown in Flowchart II-2 above. This repetitive selecting and screening process continues until the treatment for a given batch of starting materials from FIG. 1 (Flowchart I) have been finished.

Referring to FIG. 4 (Flowchart IV), a diagram illustrating an exemplary engineered portion for collecting and harvesting clean (fine) coal according to the disclosed invention. Specifically, the clean (fine) coal from FIG. 3 (Flowchart III-4b) described above is subject to a fine coal sieve. Thus resulted plus mesh material from the fine coal sieve is clean (fine) coal, which is harvested as final product, while thus resulted undersieves (minus mesh) material passing through the fine coal sieve flows into a de-soiled water pool, which is pumped by a feeding pump for a first floating selection separator into the first floating selection separator, via a pre-treatment tank, as shown in FIG. 9 (Flowchart IX-3) below.

Referring to FIG. 5 (Flowchart V), a diagram illustrating an exemplary engineered portion for a second cyclone separator of coal gangue resulted from the first cyclone separator according to the disclosed invention. Specifically, the coal gangue from FIG. 2 (Flowchart II-4c) above flows into a coal middlings and coal gangue holding pool, from where pumped by a feeding pump for the second cyclone separator into the second cyclone separator. The second cyclone separator separates the mixture of coal middlings and coal gangue into the followings:

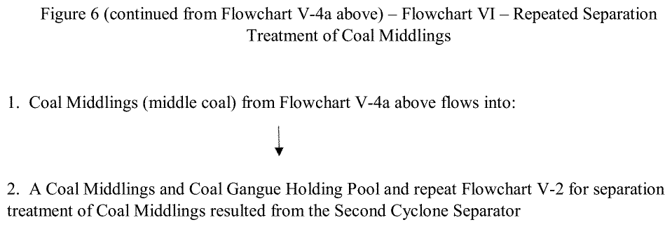

(a). coal middlings (middle coal), which shall follow FIG. 6 (Flowchart VI) below,

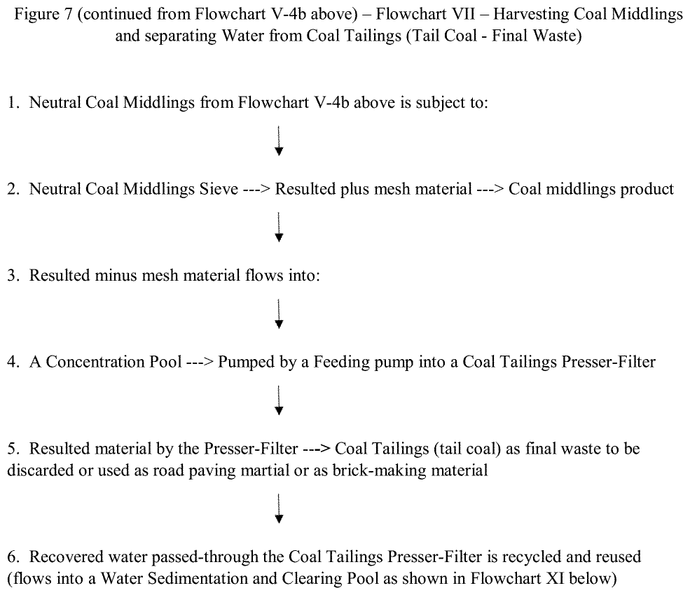

(b). neutral coal middlings, which shall follow FIG. 7 (Flowchart VII) below, and

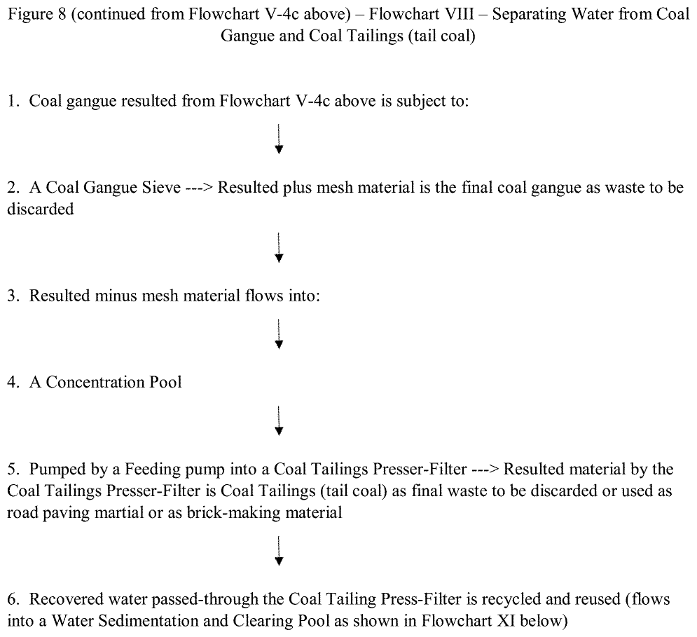

(c). coal gangue, which shall follow FIG. 8 (Flowchart VIII) below.

Referring to FIG. 6 (Flowchart VI), a diagram illustrating an exemplary engineered portion for repetitive selecting and screening processing the coal middlings produced by the second cyclone separator according to the disclosed invention. Specifically, the coal middlings (middle coal) from FIG. 5 (Flowchart V-4a) above flow into a coal middlings and coal gangue holding pool as shown in FIG. 5 (Flowchart V-20) above and repeat the separation treatment by the second cyclone separator for the coal middlings generated by the second cyclone separator from the immediately prior step. This repetitive selecting and screening process continues until the treatment for a given batch of starting materials from FIG. 1 (Flowchart I) have been finished.

Referring to FIG. 7 (Flowchart VII), a diagram illustrating an exemplary engineered portion for collecting and harvesting coal middlings and separating water from tailings according to the disclosed invention. Specifically, the neutral coal middlings from FIG. 5 (Flowchart V-4b) above are subject to a neutral coal middlings sieve. The plus mesh material resulted from the neutral coal middlings sieve is harvested as coal middlings product, while the minus mesh material resulted from the neutral coal middlings sieve flows into a concentration pool, from where pumped by a feeding pump into a coal tailings presser-filter. From the coal tailings presser-filter, coal tailings as the final waste, are discarded or used as road paving or brick-making materials, while the recovered water that passed through the coal tailings presser-filter is recycled and reused, which flows into a water sedimentation and clearing pool as shown in FIG. 9 (Flowchart IX) below.

Referring to FIG. 8 (Flowchart VIII), a diagram illustrating an exemplary engineered portion for separating water from coal gangue and coal tailings according to the disclosed invention. Specifically, the coal gangue resulted from FIG. 5 (Flowchart V-4c) above is subject to a coal gangue sieve. Thus resulted plus mesh material is the final coal gangue as waste to be discarded, while thus resulted minus mesh material flows into a concentration pool, from where pumped by a feeding pump into the coal tailings presser-filter. Resulted material by the coal tailings presser-filter is coal tailings (tail coal) as final waste to be discarded or used as road paving martial or as brick-making material. The recovered water passed-through the coal tailings presser-filter is recycled and reused which flows into the water sedimentation and clearing pool as shown in FIG. 9 (Flowchart IX) below.

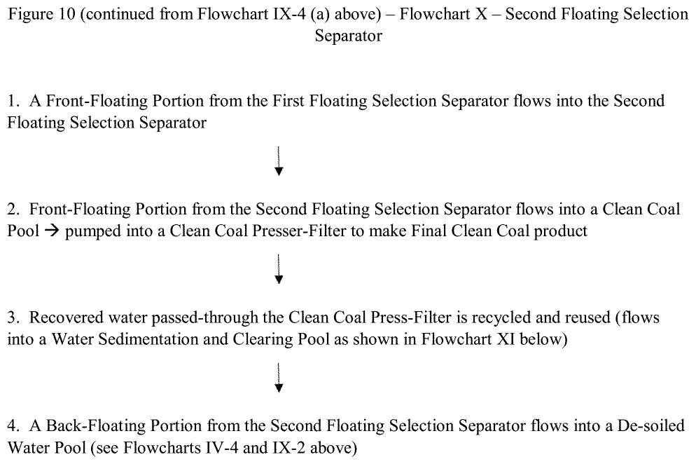

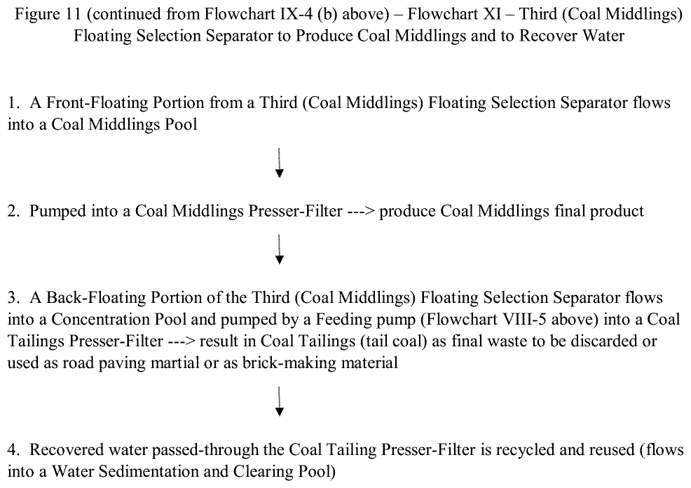

Referring to FIG. 9 (Flowchart IX), a diagram illustrating an exemplary engineered portion for the first floating selection separator according to the disclosed invention. Specifically, the undersieves (minus mesh) material resulted from the de-soiling sieve of FIG. 1 (Flowchart I-7) above flows into a de-soiled water pool and mixed with the minus mesh material resulted from the fine coal sieve after the first cyclone separator as shown in FIG. 4 (Flowchart IV-3 above) and a back-floating portion from a second floating selection separator shown in FIG. 10 (Flowchart X-4) below. From the de-soiled water pool, the mixture is pumped by a feeding pump for the first floating selection separator, via a pre-treatment tank, wherein mixing and controlling foaming take place. From the pre-treatment tank, the mixture flows into the first floating selection separator. From the first floating selection separator, resulting (a) a front floating portion that flows into the second floating selection separator, which shall follow FIG. 10 (Flowchart X) below; and (b) a back-floating portion that flows into a third (coal middlings) floating selection separator, which shall follow FIG. 11 (Flowchart XI) below.

Referring to FIG. 10 (Flowchart X), a diagram illustrating an exemplary engineered portion for the second floating selection separator according to the disclosed invention. Specifically, a front-floating portion from the first floating selection separator, as shown in FIG. 9 (Flowchart IX-4a) above, flows into the second floating selection separator. Then, a front-floating portion from the second floating selection separator flows into a clean coal pool, from which it is pumped into a clean coal presser-filter for making final clean coal product. Recovered water that passed through the clean coal presser-filter is recycled and reused, which flows into a water sedimentation and clearing pool as shown in FIG. 11 (Flowchart XI) below. A back-floating portion from the second floating selection separator flows into a de-soiled water pool as shown in FIGS. 4 and 9 (Flowcharts IV-4 and IX-2) above.

Referring to FIG. 11 (Flowchart XI), a diagram illustrating an exemplary engineered portion for the third (coal middlings) floating selection separator to produce coal middlings and recover water according to the disclosed invention. Specifically, a front-floating portion from the third (coal middlings) floating selection separator, as shown in FIG. 9 (Flowchart IX-4b) above, flows into a coal middlings pool, from where pumped into a coal middlings presser-filter to produce coal middlings as final product. A back-floating portion of the same third (coal middlings) floating selection separator flows into a concentration pool and is pumped by a feeding pump, as shown in FIG. 8 (Flowchart VIII-5 above) into a coal tailings presser-filter. The coal tailings presser-filter produces coal tailings (tail coal) as the final waste that is discarded or used as road paving martial or as brick-making material. Recovered water that passed through the coal tailings presser-filter flows into a water sedimentation and clearing pool and is recycled and reused.

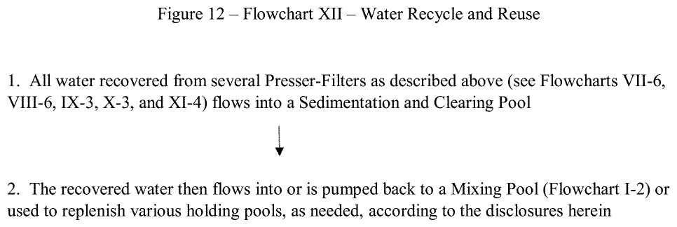

Referring to FIG. 12 (Flowchart XII), a diagram illustrating an exemplary engineered portion for water recycle and reuse according to the disclosed invention. Specifically, all recovered water passed through from the presser-filters shown in FIGS. 7, 8, 9, 10, and 11 (Flowcharts VII-6, VIII-6, IX-3, X-3, and XI-4) above flows into a sedimentation and clearing pool, from which the recovered water then flows into or is pumped back into a mixing pool as shown in FIG. 1 (Flowchart I-2) above or used to replenish various holding pools as needed.

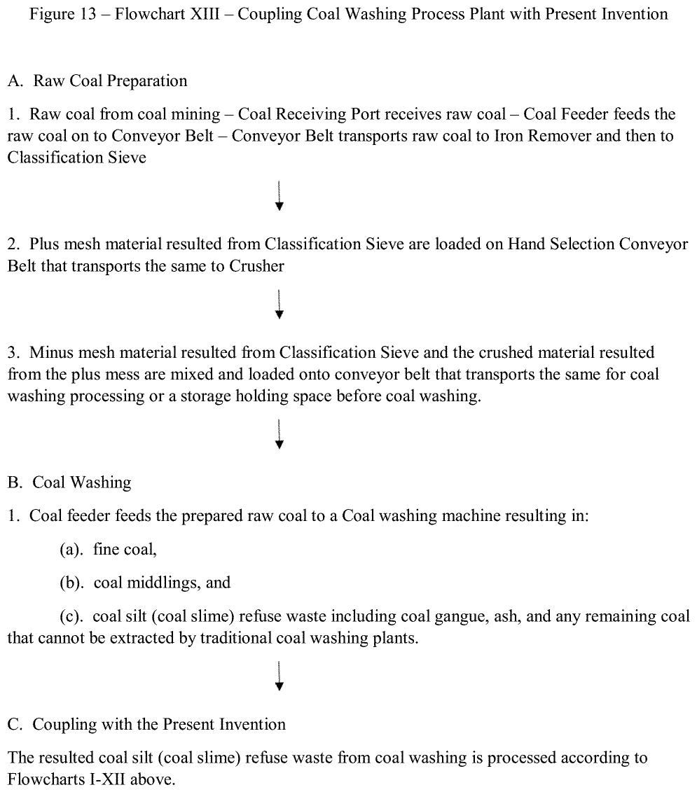

Referring to FIG. 13 (Flowchart XIII), a diagram illustrating an exemplary engineered portion for coupling the present invention with a traditional coal washing processing plant according to the discloses herein. Specifically, raw coal from coal mining, received by the coal receiving port of a coal washing plant, fed to a conveyor belt that transports the raw coal to an iron remover, then subject to a classification sieve. The plus mesh coal materials resulted from the classification sieve are loaded onto a hand selection conveyor belt that transports the same to a crusher. The minus mesh coal materials resulted from said classification sieve and the above crusher treated materials are mixed (hereafter referred to as “prepared raw coal”) and transported to coal washing, or to a storage holding place before coal washing. The prepared raw coal materials, subject to coal washing, produce clean coal and coal middlings as viable commercial products, but the byproduct, coal silt (slime) refuse, as waste, if discarded as pollutants, would impose negative environmental implications, both in the short and long terms, as shown in the background portion in the present disclosures. However, when coupled with the disclosed invention, as described and illustrated, for example, in FIGS. 1-12 (Flowcharts I-XII), additional commercially viable coal products such as clean coal and coal middlings are extracted from the coal refuse waste; water, as a valuable natural resource, used in the process are recovered, recycled, and reused in the closed system; and even the final coal waste resulted from the present invention, is not only in a much reduced amount, compared with conventional coal washing or preparation operations or coal mining processes, but also now useful as road-paving or brick-making materials, with minimal negative impact, if any, to the environment.

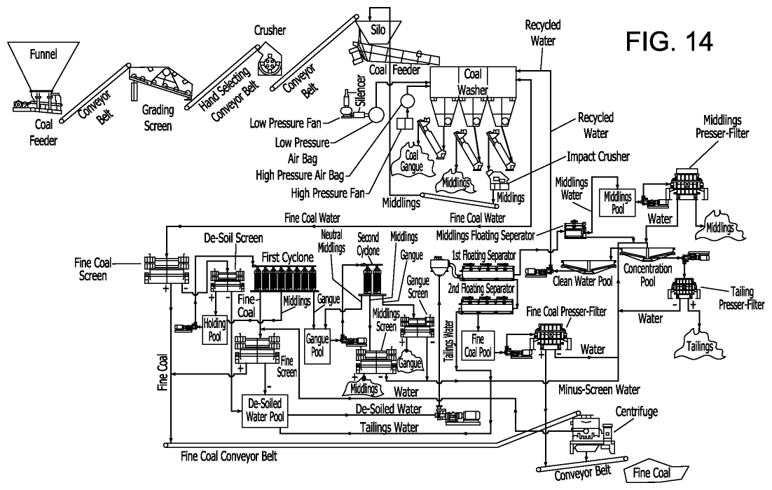

Referring to FIG. 14, Schematic Diagram of Present Invention Coupled with Coal Washing Plant, as illustrating an exemplary engineered portion for coupling the present invention with a traditional coal washing processing plant according to the discloses herein.

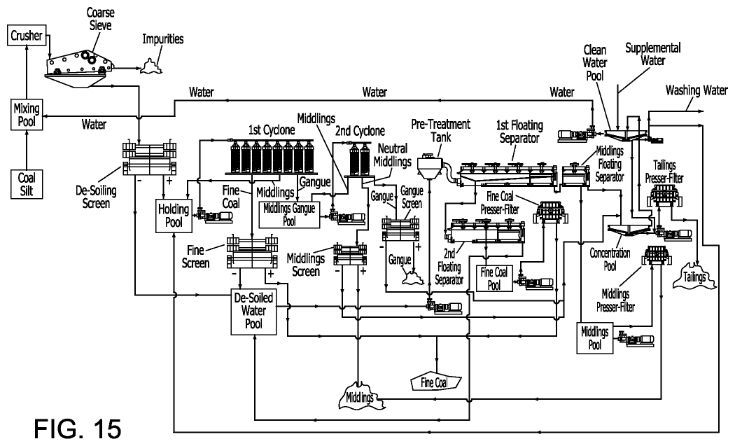

Referring to FIG. 15, Schematic Diagram of Present Invention, as illustrating an exemplary engineered portion for present invention as standing alone clean coal production plant according to the discloses herein.

The presently disclosed invention can recover coal components from coal refuse (waste), resulting in clean (fine) coal as products. About 80% of the coal content from the coal washing tailings generated by presently operating coal washing plants, which dispose or otherwise discard the coal tailings as coal refuse wastes with tremendous negative environmental implications. The clean (fine) coal products are valuable commodities, which are very much in demand for the industries such as electric power generation, iron and steel, cement production, heating, just to name a few. The clean (fine) coal production technologies as illustrated in the presently disclosed invention will add value to presently existing coal mining and coal washing operations, increase existing coal industry related job opportunities, improve economics, decrease pollutions to the environment from the existing coal industry globally.

Furthermore, the clean coal technologies disclosed in the present invention can be used to recover clean coal from discarded coal wastes left behind from the past, cumulated over the years or even decades, by coalmines and coal washing plants, which may no longer be in operations, thereby creating much needed new job opportunities, revitalizing local economics, reclaiming hazardous and polluted landmass, and turning the same into landscapes ready to be beautified, used, and enjoyed by many generations to come.

Samples (coal washing tailings delivered from different coal washing plants or different production batches of coal washing tailings delivered from a given coal washing plant) are obtained and tested to determine the initial baseline (or starting point) for their coal content (weight of coal content/total weight of coal washing tailings, expressed in %). Final clean coal (fine coal) products resulted from the presently disclosed invention are measured at their output points (plus screen and minus screen, respectively) and calculated against the initial baseline (starting point) coal content to determine the recovery rate (%). On average, the recovery rate of clean (fine) coal as products from the presently disclosed invention is about 80%, as shown in Table 1 with data points illustrating coal recovery rate of the disclosed invention in comparison with coal recovery rate of traditional coal washing plants

TABLE 1

| | | | | Total | Final |
|---|---|---|---|---|---|
| | | | | recovered coal | Recovery Rate |
| | Initial | Coal recovered | Coal recovered | (recovered from plus | (total recovered |
| Sample | Coal Content | from plus screen | from minus screen | screen + recovered | coal/initial |
| Number | (100-ash %) | (0.1-2 mm) | (0-0.1 mm) | from minus screen) | coal content %) |
| 1 | 73.33 | 29.6 + 2.5 = 32.1 | 24.9 | 32.1 + 24.9 = 57 | 57/73.33 = 78 |
| (Mar. 22, 2020) | | | | | |
| 4 | 67.97 | 26.7 + 20 = 46.7 | 17.7 | 46.7 + 17.7 = 64.4 | 64.4/67.97 = 95 |
| (Apr. 2, 2020) | | | | | |
| 5 | 72.93 | 19.7 + 4 = 32.7 | 42.7 | 32.7 + 42.7 = 66.4 | 66.4/72.93 = 91 |
| (Apr. 5, 2020) | | | | | |
| 6 | 68.4 | 20.6 + 15.8 = 36.4 | 18.1 | 36.4 + 18.1 = 54.5 | 54.5/68.4 = 80 |
| (Apr. 6, 2020) | | | | | |
| 7 | 69 | 24.6 + 14.8 = 39.4 | 10.8 | 39.4 + 10.8 = 50.2 | 50.2/69 = 73 |
| (Apr. 11, 2020) | | | | | |
| 8 | 63.1 | 5.8 + 0.8 = 6.6 | 32.2 | 6.6 + 32.2 = 38.8 | 38.8/63.1 = 62 |
| (Apr. 13, 2020) | | | | | |
| Apr. 15, 2020 | 64.13 | 23.1 + 4.3 = 27.4 | 26.6 | 27.4 + 26.6 = 54 | 54/64.13 = 84 |
| (2697) | | | | | |
| Apr. 15, 2020 | 57.2 | 24.1 + 19.1 = 43.2 | 7.9 | 43.2 + 7.9 = 51.1 | 51.1/57.2 = 89 |
| (2698) | | | | | |
| Apr. 16, 2020 | 60 | 24.4 + 13.4 = 37.8 | 6.5 | 37.8 + 6.5 = 44.3 | 44.3/60 = 74 |
| (2612) | | | | | |
| Apr. 16, 2020 | 56.11 | 23.1 + 4.5 = 27.6 | 15 | 27.6 + 15 = 42.6 | 42.6/56.11 = 76 |
| (2699) | | | | | |
| | | | | | Average: 80% |

While the present invention has been described as having different embodiments, the invention may be further modified within the spirit and scope of the disclosures herein. This application is therefore intended to cover any variations, uses, or adaptations of the disclosed invention using its general principles. Furthermore, these disclosures are intended to cover such departures from, changes, or substitutions of the present disclosures made by those skilled in the art or as within known or customary practice in the art to which this invention pertains to and which fall within the limits of the appended claims.

What is claimed is:

1. A system of clean coal production from coal refuse waste comprising:
a screen series,
a cyclone separator series,
a floating selection separator series, and
a presser-filter series.

2. The system of claim 1, wherein the screen series comprising:
a coarse sieve,
a de-soiling sieve,
a fine coal sieve,
a coal middlings sieve, and
a coal gangue sieve.

3. The system of claim 2, wherein the cyclone separator series comprising:
a first cyclone separator, and
a second cyclone separator.

4. The system of claim 3, wherein the floating selection separator series comprising:
a first floating selection separator,
a second floating selection separator, and
a third floating selection separator.

5. The system of claim 4, wherein the presser-filter series comprising:
a coal tailings presser-filter,
a clean coal presser-filter, and
a coal middlings presser-filter.

6. A system of clean coal production from coal refuse waste coupled with coal washing plants comprising:
a screen series,
a cyclone separator series,
a floating selection separator series, and
a presser-filter series.

7. The system of claim 6, wherein the screen series comprising:
a classification sieve,
a coarse sieve,
a de-soiling sieve,
a fine coal sieve,
a coal middlings sieve, and
a coal gangue sieve.

8. The system of claim 6, wherein the cyclone separator series comprising:
a first cyclone separator, and
a second cyclone separator.

9. The system of claim 6, wherein the floating selection separator series comprising:
a first floating selection separator,
a second floating selection separator, and
a third floating selection separator.

10. The system of claim 6, wherein the presser-filter series comprising:
a coal tailings presser-filter,
a clean coal presser-filter, and
a coal middlings presser-filter.

11. A method of clean coal production from coal refuse waste comprising performing steps of:
(1). series screening treatment step,
(2). series cyclone separation treatment step,
(3). series floating selection separation treatment step, and
(4). series presser-filter treatment step.

12. The method of claim 11, wherein the series screening treatment step comprising the use of:
a coarse sieve,
a de-soiling sieve,
a fine coal sieve,
a coal middlings sieve, and
a coal gangue sieve.

13. The method of claim 11, wherein the series cyclone separation treatment step comprising the use of:
a first cyclone separator, and
a second cyclone separator.

14. The method of claim 11, wherein the series floating selection separation treatment step comprising the use of:
a first floating selection separator,
a second floating selection separator, and
a third floating selection separator.

15. The method of claim 11, wherein the series presser-filter treatment step comprising the use of:
a coal tailings presser-filter,
a clean coal presser-filter, and
a coal middlings presser-filter.

16. The method of claim 11, wherein the series screening treatment step comprising the use of:
a classification sieve,
a coarse sieve,
a de-soiling sieve,
a fine coal sieve,
a coal middlings sieve, and
a coal gangue sieve.

17. The method of claim 16, wherein the series cyclone separation treatment step comprising the use of:
a first cyclone separator, and
a second cyclone separator.

18. The method of claim 16, wherein the series floating selection separation treatment step comprising the use of:
a first floating selection separator,
a second floating selection separator, and
a third floating selection separator.

19. The method of claim 16, wherein the series presser-filter treatment step comprising the use of:
a coal tailings presser-filter,
a clean coal presser-filter, and
a coal middlings presser-filter.
